(19) United States
(12) Patent Application Publication
(10) Pub. No.: US 2002/0099863 A1
(43) Pub. Date: Jul. 25, 2002

(54) Software support layer for processors executing interpreted language applications

(76) Inventors: Guillaume Comeau, Quebec (CA); Vincent Deschenes, Ottawa (CA)

Correspondence Address: Pillsbury Winthrop LLP, Intellectual Property Group, 50 Fremont Street, San Francisco, CA, 94105-2228, US

(21) Appl. No.: 09/767,038

(22) Filed: Jan. 22, 2001

Related U.S. Application Data
(60) Provisional application No. 60/208,967, filed on Jun. 2, 2000.
(60) Provisional application No. 60/217,811, filed on Jul. 12, 2000.
(60) Provisional application No. 60/228,540, filed on Aug. 28, 2000.

(51) Int. Cl. G06F 9/00; G06F 9/54; G06F 15/163

(52) U.S. Cl. 709/310

(57) ABSTRACT

An apparatus that supports processors executing interpreted language applications. A software support layer combined with a virtual machine provides a consistent programming view to application programmers across platforms. The support layer comprises functionality missing from the virtual machine, which when combined with the virtual machine, eliminates the need for an operating system.

### RELATED APPLICATIONS

This application claims the benefit of co-pending U.S. Provisional Application Serial No. 60/208,967 filed Jun. 2, 2000, co-pending U.S. Provisional Application Serial No. 60/217,811 filed Jul. 12, 2000, and co-pending U.S. Provisional Application Serial No. 60/228,540, filed Aug. 28, 2000.

### BACKGROUND

1. Field of the Invention

Aspects of the present invention relate in general to an apparatus for supporting processors executing interpreted language applications.

2. Description of the Related Art

Conventional embedded Java solutions use a Java Virtual Machine (JVM) layered on top of a real time operating system (RTOS), which in turn is on top of a general-purpose microprocessor or micro-controller. Because there are multiple levels of hierarchy, integrating peripheral drivers is difficult organizationally and technically. The peripheral drivers, written in C, have to be integrated into a hardware device, in addition to integration with both a real time operating system and the Java virtual machine. The integration is organizationally difficult because engineers have to deal with hundreds of pages of manuals from possibly three different vendors. Moreover, integration yields a technically undesirable result. A Java Virtual Machine layered on a real time operating system solution is typically very slow. For example, a Java no-operation (“NOP”) can take up to 17 processor machine cycles to execute. Consequently, the resulting system response is either unacceptably slow to the user, or a very high-speed processor must be used. However, if a high-speed processor is used, the high-speed processor often consumes unacceptably high power, which is a major concern in battery powered devices, such as wireless phones and personal digital assistants (PDAs). Moreover, a large memory is required for both the Java virtual machine and real time operating system, on top of any memory requirements for any applications.

A variety of solutions have been attempted to solve the slow execution speed of a Java virtual machine operating in conjunction with a real time operating system on a processor. Each solution poses its own problems.

One solution is to develop a Java byte-code hardware co-processor, which works with a Java virtual machine running on a host processor as the controller. In this case the Java application execution speed can be improved, but a Java virtual machine is still required on top of the real time operating system on the host processor. With this approach, integration problems may be made more difficult and the Java applications do not have good access to the device peripherals attached to the main processor. In addition, an increased memory is required. Power consumption and size may still be an issue as there are effectively two processors required.

Another problem may result when software application development occurs on an unfinished platform, such as a Java virtual machine layered on real time operating system. This is the case when application developers write Java code using tools that fail to accurately reflect the final target hardware environment. Because developers can not wait until the target hardware is complete and the real time operating system port finished, their code may require revisions after the hardware release. This results in added development time.

### BRIEF DESCRIPTION OF THE DRAWINGS

FIG. 1 illustrates an embodiment of an apparatus that supports processors executing interpreted language applications.

FIGS. 2 A-C are block diagrams of embodiments of an apparatus support processors executing interpreted language applications.

FIG. 3 is a block diagram of a Java Support Machine (JSM) embodiment of an apparatus that supports processors executing interpreted language applications.

FIG. 4 is a memory map illustrating an embodiment boot loader configuration in computer memory.

FIG. 5 is a block diagram of an embodiment of a software support interrupt vector table mapping interrupt vectors, descriptors, and functions to their equivalents in a processor interrupt vector table.

### DETAILED DESCRIPTION

Aspects of the present invention include an apparatus that supports processors executing interpreted language applications without the need to take into account the integration problems associated with use of a real time operating system, that minimizes or eliminates the operating system and/or processor platform dependency, and yet provides a low-power, small-memory footprint alternative. In the embodiments, a software support layer, combined with a virtual machine (VM), provides a consistent programming view to application programmers across platforms. The software support layer comprises functionality missing from the virtual machine, which when combined with the virtual machine, eliminates the need for an operating system. Application development is separated from individual processor platforms via the support layer and virtual machine, the combination of which may be referred to as a “support machine.” In the embodiments, the use of dual-interrupt vector tables enables the support layer's design to be independent of the processor platform.

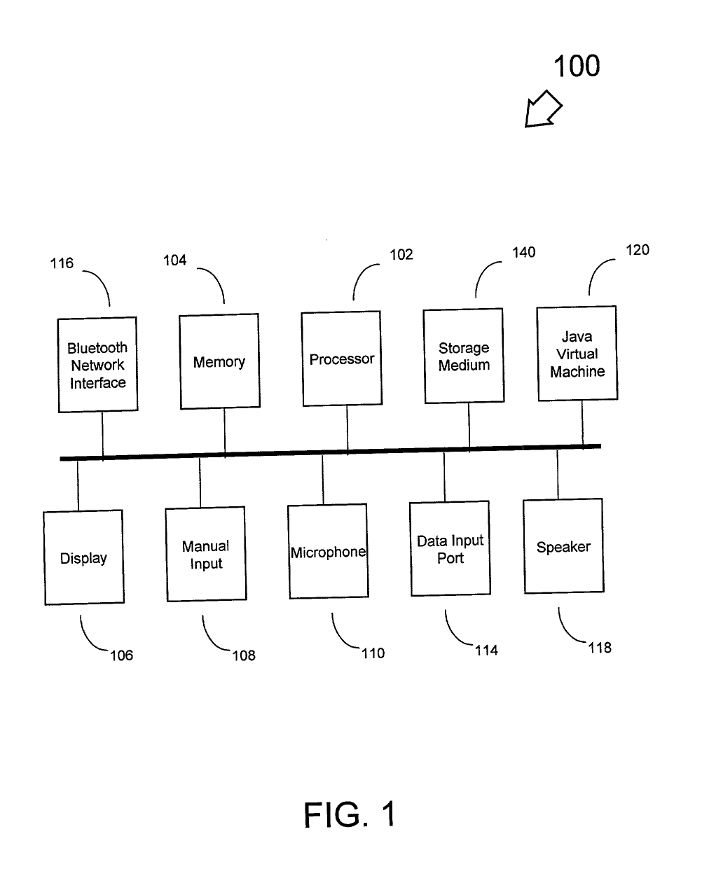

FIG. 1 is a simplified functional block diagram depicting apparatus 100, constructed and operative in accordance with an embodiment of the present invention. Apparatus 100 includes at least one processor 102, sometimes referred to as a central processing unit or “CPU.” Processor 102 may be any microprocessor or micro-controller as is known in the art. The software for programming the processor 102 may be found at a computer-readable storage medium 140, in memory 104, or, alternatively, from another location across a personal area network. Memory 104 may be resident or integrated on processor 102.

In some embodiments, apparatus 100 is a wireless phone, personal digital assistant (PDA), personal computers, cameras, scanners, printers or any computer peripheral devices as is known in the art.

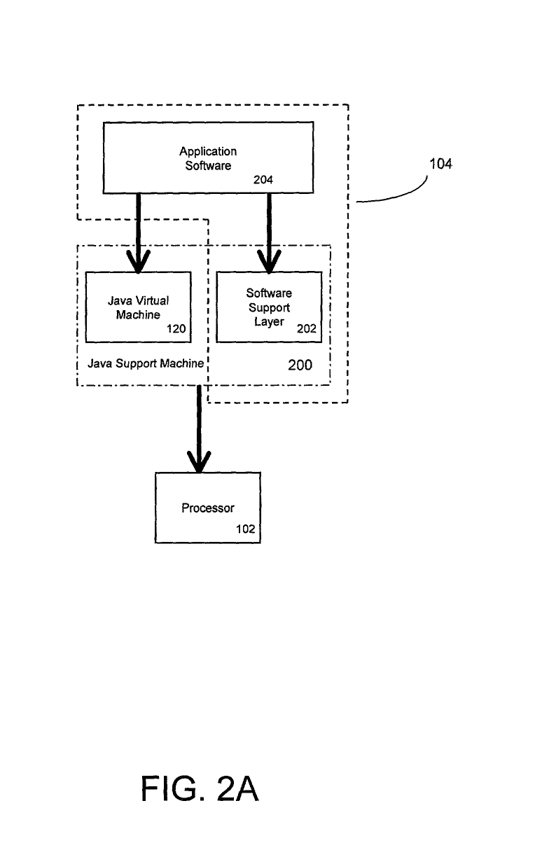

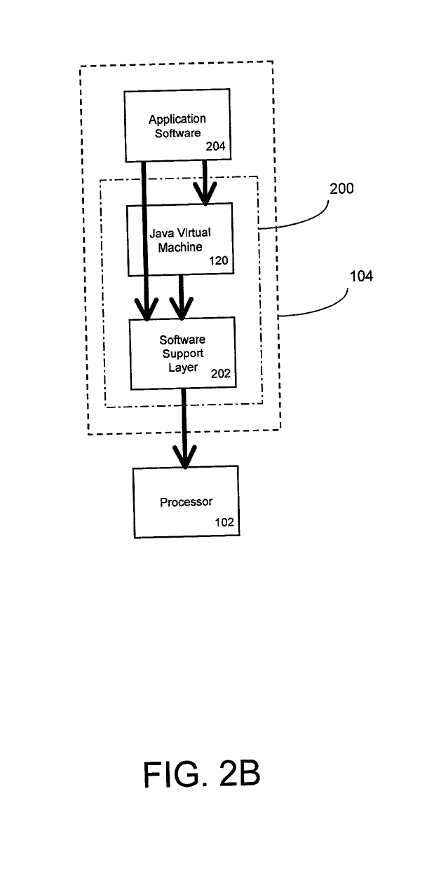

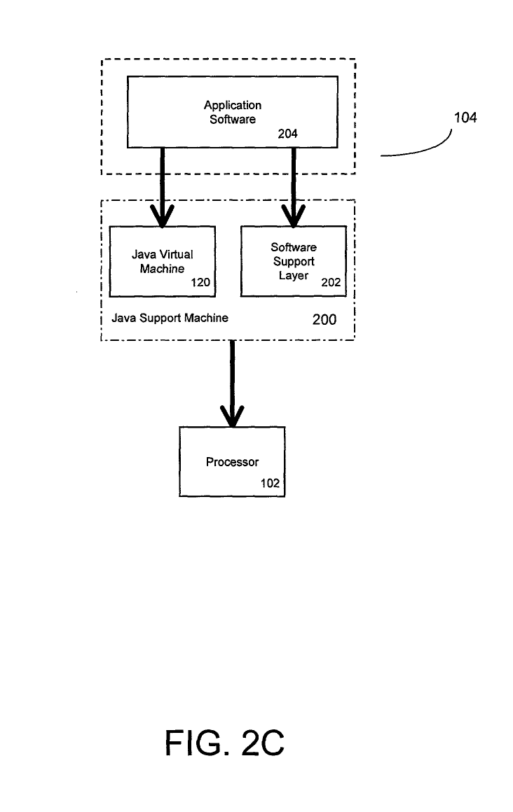

In some embodiments, processor 102 may be integrated with a Virtual Machine (VM) 120. In one embodiment, the virtual machine is a Java Virtual Machine (JVM), available from Sun Microsystems. In some embodiments, VM 120 performs a number of functions that can include class loading, process threading, object locking, byte-code interpretation, and/or byte-code execution. As detailed below with reference to FIGS. 2A-C, VM 120 operates in conjunction with a software support layer 202.

It is well understood by those known in the art that VM 120 may be implemented in hardware, firmware, and/or software encoded on a computer readable medium. A computer readable medium is any medium known in the art capable of storing information. Computer readable media include Read Only Memory (ROM), Random Access Memory (RAM), flash memory, Erasable-Programmable Read Only Memory (EPROM), non-volatile random access memory, memory-stick, magnetic disk drive, floppy disk drive, compact-disk readonly-memory (CD-ROM) drive, transistor-based memory or other computer-readable memory devices as is known in the art for storing and retrieving data.

Apparatus 100 is configured to support processors executing interpreted language applications. Interpreted languages are any computer languages known in the art that performs translation of a program instruction and executes the program instruction before proceeding to the next program instruction. Examples of such languages include, but are not limited to, BASIC (Beginners All-purpose Symbolic Instruction Code), LISP (LISt Processor), and Tcl. Another example is a Java or Java-like programming language.

For illustrative purposes only, the following example embodiments utilize a Java or Java-like programming language. It is understood, by those known in the art, that these principles may apply equally well to any interpreted language. In one embodiment, VM 120 interprets Java or Java-like software instructions embodied as byte-codes into machine code. The Java or Java like software instructions may include, but are not limited to Java 2 Platform, Enterprise Edition (J2EE™), Java 2 Platform, Standard Edition (J2SE™), and Java 2 Platform, Micro Edition (J2ME™) programming languages available from Sun Microsystems; or, for example, C-Sharp available from Microsoft Corporation.

Apparatus 100 may also include a display 106, manual input device 108, microphone 110, data input port 114, and Bluetooth network interface 116. Display 106 may be a visual display such as a cathode ray tube (CRT) monitor, a liquid crystal display (LCD) screen, touch-sensitive screen, or other view screens as are known in the art for visually displaying images and text to a user. Manual input device 108 may be a conventional keypad, keyboard, mouse, trackball, pointing device, or other input device as is known in the art for the manual input of data. Storage medium 140 may be a conventional read/write memory such as a magnetic disk drive, floppy disk drive, compact-disk read-only-memory (CD-ROM) drive, transistor-based memory or other computer-readable memory device as is known in the art for storing and retrieving data. Significantly, storage medium 140 may be remotely located from processor 102, and be connected to processor 102 via a network such as a Personal Area Network (PAN), a local area network (LAN), a wide area network (WAN), or the Internet.

Microphone 110 may be any suitable microphone as is known in the art for providing audio signals to processor 102. In addition, a speaker 118 may be attached for reproducing audio signals from processor 102. It is understood that microphone 110 and speaker 118 may include appropriate digital-to-analog and analog-to-digital conversion circuitry as appropriate. In some embodiments, the microphone 110 and speaker 118 may be part of, or used in wireless or wired phone embodiments

Data input port 1 14 may be any data port as is known in the art for interfacing with an external accessory using a data protocol such as RS-232, Universal Serial Bus (USB), or Institute of Electrical and Electronics Engineers (IEEE) Standard No. 1394 (‘Firewire’). In some embodiments, data input port 114 may be used for communicating or transferring files across a computer network, examples of such networks include Transmission Control Protocol/Internet Protocol (TCP/IP), Ethernet, Fiber Distributed Data Interface (FDDI), token bus, or token ring networks.

Network interface 116 is an interface that allows apparatus 100 to communicate via the Bluetooth wireless network protocol. In other embodiments, network interface 116 may consist of an interface to another network protocol.

FIGS. 2A-C are expanded functional block diagrams of processor 102 and memory 104, constructed and operative in accordance with an embodiment of the present invention. The functional elements of FIGS. 2A-C may be implemented in hardware, firmware, and/or as software instructions and data encoded on a computer-readable storage medium 140.

As shown in FIGS. 2A-C, application software 204, runs on a Java support machine 200, which interfaces with the central processing unit 102. Java support machine 200 is functionally comprised of a VM 120 and a software support layer 202.

FIG. 2A illustrates an embodiment in which the software support layer 202 and application software 204 are implemented as software stored in computer memory 104. In this embodiment, Java VM 120 may also be implemented as a hardware or firmware component, for example, as byte-codes executable by processor 102 as micro-instructions.

FIG. 2B depicts an embodiment in which Java support machine 200 exists entirely in memory 104.

FIG. 2C illustrates an embodiment in which Java support machine 200 is a firmware or hardware structure.

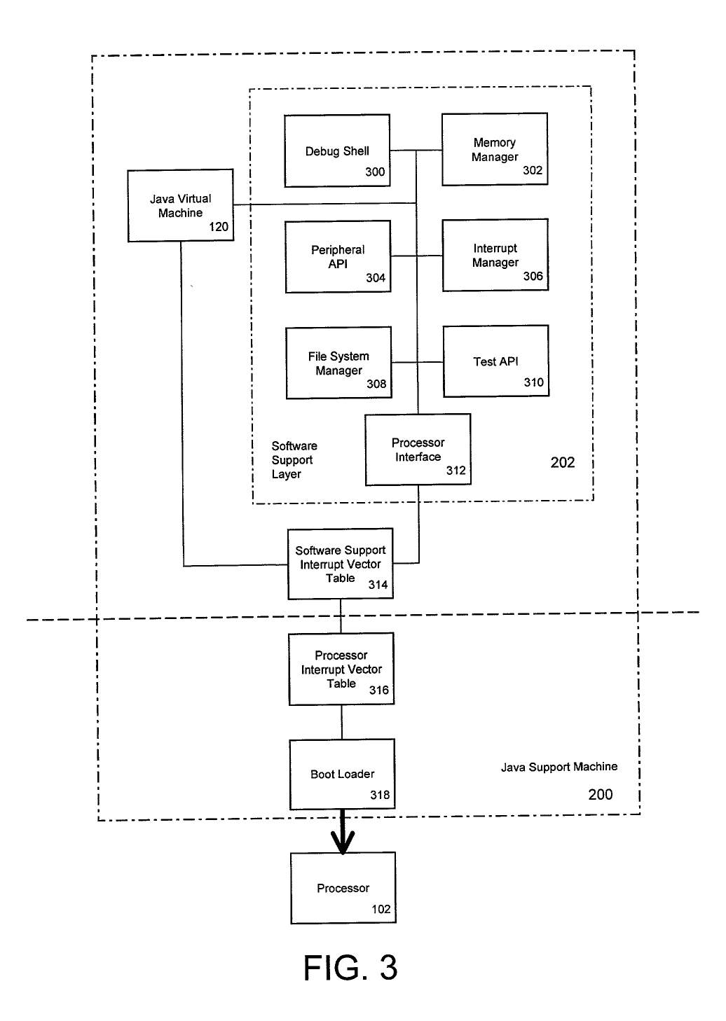

Software support layer 202 is a structure that supports the execution of application software 204 on a processor 102, and is described with greater detail in FIG. 3.

FIG. 3 is expanded functional block diagrams of processor 102 and Java support machine 200, constructed and operative in accordance with an embodiment of the present invention.

The embodiment of support layer 202 has the ability to abstract out processor architectures and the nature of the connectivity provided by a particular platform to virtual machine 120. As shown in FIG. 3, VM 120 and software support layer 202 interface with a processor interrupt vector table 316, support layer interrupt vector table 314 and boot loader 318.

In some embodiments, virtual machine 120 and the software support layer 202 are statically compiled together to form a single executable binary image with a static link between the interrupt vector tables and the virtual machine.

In conventional systems, it is problematic to easily map interrupts to a thread. Compiling the virtual machine 120 and the software support layer 202 together, with tight linkages between them, results in a fast and compact implementation.

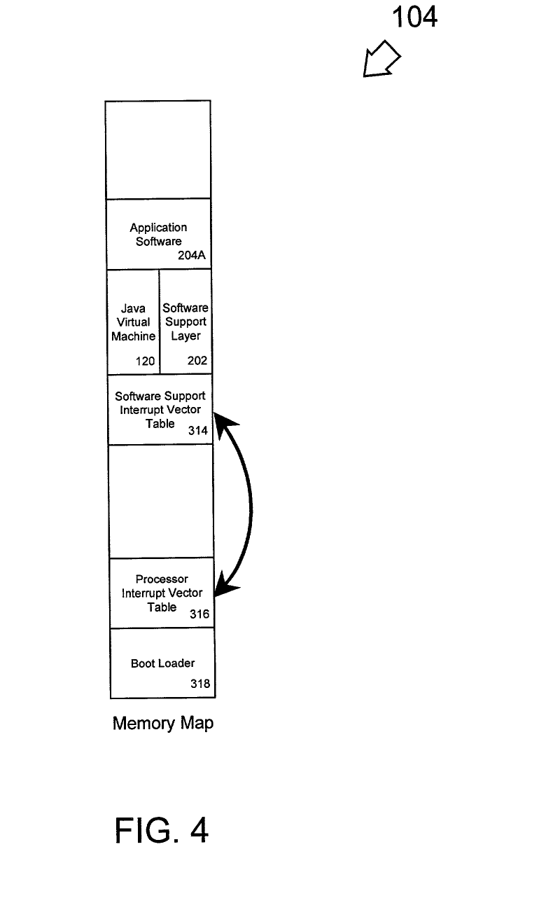

The abstraction of using two interrupt vector tables 314, 316 provides developers a consistent view for application programmers developing application software 204 for Java support machine 200. When virtual machine 120 and support layer 202 are compiled together with bootloader 318, a processor interrupt vector table 316 points to a software support interrupt vector table 314. The memory map in FIG. 4 illustrates the pointing of the processor interrupt vector table 316 to the support layer interrupt vector table 314.

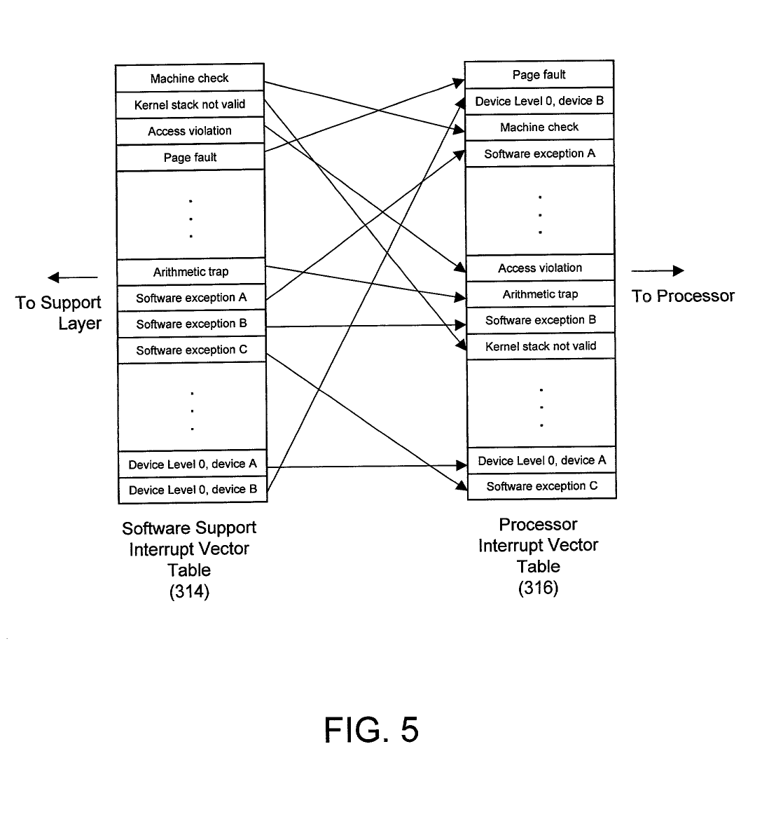

The use of the two interrupt vector tables 314 316 provides a clean interface between hardware (such as peripherals and processor 102) and a particular virtual machine 120 implementation. As shown in FIG. 5, the processor-independent software support interrupt vector table 314 maps interrupt vectors, descriptors and functions to their equivalents in a processor interrupt vector table 316. The mapping of vectors from the software support interrupt vector table 314 to the processor interrupt vector table 316 may also be referred to as “overlapping” the processor interrupt vector table 316.

Because the structures located above the horizontal dashed line of FIG. 3 (virtual machine 120 and software support layer 202) are developed with a standard application interface that is platform and processor independent, applications may be developed for a processor 102, regardless of the processor and/or processor platform used. For example, with embodiments of the present invention, one application could be developed that would be capable of being executed on two differing processor platforms with no or few changes to the application. This means, for example, software applications written for an embodiment in a digital wireless phone could also be used in a different embodiment in a personal computer-based desktop development environment seamlessly. Furthermore, with embodiments of the present invention, applications could be transferred between different brands and manufacturers of devices and be executed dynamically without the need for a compilation step that could slow down the execution of the application.

Sometimes called a “bootstrap,” bootloader 318 is a processor-specific structure that initiates the support machine 200 control over processor 102. Bootloader 318 may be any program known in the art that first executes when the processor 102 is started, then transfers control to support machine 200.

Moreover, separation of the bootloader 318 and the virtual machine 120/software support layer 202 combination allows the application to be upgraded in the field. However, the static nature of the software blocks allows speed improvements over classical implementations with relocatable code.

Returning to FIG. 3, as mentioned above, it is understood that portions of support machine 200 may be implemented in hardware, firmware, and/or software stored in a computer readable memory. Such computer memories include random access memory (RAM), non-volatile random access memory, read only memory (ROM), flash memory, Erasable-Programmable Read Only Memory (EPROM), memory-stick, or other computer-readable memory device as is known in the art for storing and retrieving data.

The support layer 202 may be designed to require a small amount of memory and may provide additional functionality which when combined with a virtual machine 120 may be used to eliminate the need for an operating system. This functionality may include an interface to peripherals, string functions, memory operations, file system/stream features, interrupt management, and boot loader.

However, in some embodiments, support layer 202 may be applied to a virtual machine running in a development environment. Examples of such development environments include a personal computer or workstation running an operating system, on a general purpose embedded processor running a virtual machine on top of a commercial operating system, or directly on a processor which is optimized to execute the interpreted language directly in hardware. Examples of operating systems within the scope of the embodiments present invention that support Java or Java-like languages contemplated for use with host and/or a target devices, include, but are not limited to: WIN32, Unix, Macintosh OS, Linux, DOS, PalmOS, and Real Time Operating Systems (RTOS) available from manufacturers such as Acorn, Chorus, GeoWorks, Lucent Technologies, Microwave, QNX, and WindRiver Systems, which may be utilized on a host and/or a target device. With the embodiments of the present invention, therefore, it is also contemplated that applications may be written and executed and/or transferred between different processors or processor platforms running under many different operating systems.

Support layer 202 may comprise a debug shell 300, memory manager 302, peripheral application interface (API) 304, interrupt manager 306, file system manager 308, test application interface 310, and processor interface 312.

Debug shell 300 may be any element known in the art that provides debugger support for developers to test application software 204 written for the high-level interpreted language virtual machine 120. In some embodiments, boot loader 318 may contain a reset vector. The reset vector may, depending on boot conditions, launch the support layer 202 and virtual machine 120 or stay within the debug shell 300 or test API 310.

Memory manager 302 supports memory operations, such as memory allocation and memory deallocation. Furthermore, in some embodiments, memory manager 302 further supports string functions and other data operations. Moreover, memory manager 302 is the structure that allows memory addresses referenced in an application program 204 to be independent from the addresses available in storage memory 104. In some embodiments, memory manager 302 facilitates the use of virtual memory by utilizing the address translation features available in a processor 102 memory management unit (MMU).

Peripheral application interface (API) 304 is a structure within support layer 202 that provides an abstraction of hardware so that application developers can get a consistent view and communicate with peripherals and processors across the various platforms and operating systems. This consistency in peripheral API 304 results in the optimization of the application software development process. Moreover, in some embodiments, peripheral API 306 provides interpreted language level driver application interfaces to peripherals. This may be the same interpreted language as implemented by virtual machine 120. In one example embodiment, the language is Java or Java-like. In cases where the interpreted language is an object-oriented language, such as Java, hardware peripherals may be abstracted as objects in the application level language. In some embodiments, the interface to peripherals 304 may be a memory-mapped implementation.

The interrupt manager 306 is any structure, as is known in the art, that handles hardware interrupts and exceptions. In one embodiment, interrupt manager 306 adjusts for different interrupt priorities via software mapped interrupts to threads. Such an implementation allows the mapping of any type of interrupt system to a standard model compatible with the processor 102. Moreover, the interrupts can be from a single source, or vectored, or totally software simulated. The defined interrupts are then mapped to software interrupts and given their own priories all within the boundaries of the support layer 202.

In an alternate embodiment, interrupt manager 306 may adjust for different interrupt priorities via hardware priorities. However, this embodiment would be much more processor 102 dependent than the former software-mapped embodiment.

In some embodiments, interrupt manager 306 includes a scheduler that schedules virtual machine threads based on their association with a given interrupt source. In such embodiments, interrupt service routines may be tied to threads under the control of the scheduler.

In alternate embodiments, processor interface 312 provides the function calls to dynamically couple virtual machine 120 and software support layer 202 threads with interrupt manager 306. Processor interface 312 is the structure that dynamically maps threads to software support interrupt vector table 314.

File system manager 308 is any structure that supports the management of file system objects, such as files and directories. In some embodiments, file system objects are supported in a hierarchical structure. File system objects and devices are managed and accessed by interpreted language level file application interfaces to storage media 140. In embodiments where the interpreted language is an object-oriented language, such as Java, files and directories may be abstracted as objects in the interpreted language.

In some embodiments, file system manager 308 includes support for a plurality of file system devices. In one such embodiment, a file system device may be a read-only-memory (ROM) file system used to store static files. These static files include files other than Java classes.

In another embodiments, file system manager 308 provides an abstraction of a style file system. Peripheral objects, such a serial port or a ROM file system, to be represented on a virtual machine implementation as a classic “C” style file system. This allows a further layer of abstraction, so those application software 204 designers may write high-level software without having any awareness of the particulars of the underlying protocol.

Test application interface 310 supports low level hooks for manufacturing tests. Manufacturing tests may include any tests known in the art to verify functionality of software support layer 202, or Java support machine 200.

The previous description of the embodiments is provided to enable any person skilled in the art to practice embodiments of the invention. The various modifications to these embodiments will be readily apparent to those skilled in the art, and the generic principles defined herein may be applied to other embodiments without the use of inventive faculty. Thus, the present invention is not intended to be limited to the embodiments shown herein, but is to be accorded the widest scope consistent with the principles and novel features disclosed herein.

What is claimed is:

1. A support machine comprising:
an interpreted computer-language virtual machine; and
a software support layer, coupled to the virtual machine, the software support layer further comprising:
a memory manager;
a file system manager; and
an interrupt manager.

2. The support machine of claim 1, wherein the interrupt manager further comprises:
a scheduler to schedule virtual machine threads based on their association with a given interrupt source.

3. The support machine of claim 2, wherein interrupt service routines are tied to the scheduled virtual machine threads.

4. The support machine of claim 3, wherein the support layer software is coupled to the virtual machine as a single binary image.

5. The support machine of claim 4, wherein the single binary image overlaps interrupt vectors of a target processor.

6. The support machine of claim 5, wherein the single binary image includes function calls to dynamically couple the virtual machine thread with the interrupt manager.

7. The support machine of claim 6, wherein the virtual machine is a Java virtual machine.

8. The support machine of claim 1, where the software support layer is compiled with the virtual machine into a single binary image that is statically linked between a interrupt vector table and the virtual machine.

9. The support machine of claim 1, wherein the file system manager supports files in computer-readable-memory.

10. The support machine of claim 9, wherein the files in computer-readable-memory store run-time property information.

11. The support machine of claim 1, wherein the file system manager supports files in a computer-readable-medium coupled to the support machine.

12. The support machine of claim 1, further comprising:
a boot loader, the boot loader comprising a first interrupt vector table overlapping with a second vector table, the first interrupt vector table and the second interrupt vector table containing elements, wherein the elements the first interrupt vector table points to functions in the software support layer.

13. The support machine of claim 12, wherein the boot loader further comprises a reset vector to launch the support layer and virtual machine or stay within a debug shell.

14. The support machine of claim 12, wherein the single binary image includes function calls to dynamically couple the virtual machine thread with the interrupt manager.

15. The support machine of claim 12, further comprising:
a memory to store byte-codes; and
a processor to executes the bytes codes as micro-instructions.

16. The support machine of claim 15, wherein the support machine is a wireless phone.

17. The support machine of claim 15, wherein the support machine is a personal digital assistant.

18. The support machine of claim 15, wherein the support machine is a personal computer.

19. A support machine comprising:
means for interpreting a computer-language; and
means for managing memory, coupled to the means for interpreting the computer-language;
means for managing system files, coupled to the means for managing memory means for managing system interrupts, coupled to the means for managing system files.

20. The support machine of claim 19, wherein the means for managing system interrupts further comprises:
a scheduler to schedule virtual machine threads based on their association with a given interrupt source.
